(19) United States
(12) Patent Application Publication
(10) Pub. No.: US 2014/0214979 A1
(43) Pub. Date: Jul. 31, 2014

(54) PROVIDING ALERTS ON COMMUNICATION DEVICES

(71) Applicant: Bhavin Turakhia, Mumbai (IN)

(72) Inventor: Bhavin Turakhia, Mumbai (IN)

(73) Assignee: Talk.to FZC, Ras Al Khaimah (AE)

(21) Appl. No.: 13/929,500

(22) Filed: Jun. 27, 2013

(30) Foreign Application Priority Data
Jan. 29, 2013 (IN) 250/MUM/2013

(51) Int. Cl. H04L 12/58

(52) U.S. Cl. CPC H04L 51/24
USPC 709/206

(57) ABSTRACT

A method and system of providing an alert of an event on a communication device are disclosed. A determination may be made that a communication device of a user is a preferred communication device among a plurality of communication devices of the user based on an indication of an activity on the communication device. An indication of an event may be received. In response to the indication of the event, an attempt may be made to cause an alert for the event to be generated only on the preferred communication device.

### PRIORITY APPLICATION(S)

This application claims the benefit of priority under 35 U.S.C. 119(a)-(d) to Indian Application No. 250/MUM/2013, filed Jan. 29, 2013, titled “Providing Alerts on Communication Devices,” which is incorporated herein by reference in its entirety.

### TECHNICAL FIELD

The present application relates generally to the technical field of data processing, and, in various embodiments, to methods and systems of providing alerts on communication devices.

### BACKGROUND

Users often have multiple devices that they use, such as a desktop computer, a laptop computer, a tablet computer, and a mobile phone. Users may install and access chat applications, as well as other applications, across all of these devices. One annoyance associated with having multiple devices is that all of the devices are alerted whenever an event for which an alert is appropriate occurs. As a result, all of the user's devices provide an alert, which can be inefficient.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIGS. 1A-1D illustrate example embodiments of different stages of providing an alert of an event;

FIG. 2 is a flowchart illustrating an example embodiment of a method of providing an alert of an event;

FIG. 3 is a block diagram illustrating an example embodiment of an alert system;

FIG. 4 illustrates an example embodiment of indicating a user activity on a communication device;

FIG. 5 illustrates another example embodiment of indicating a user activity on a communication device;

FIGS. 6A-6B illustrate example embodiments of different stages of attempting to cause an alert of an event;

FIGS. 7A-7B illustrate other example embodiments of different stages of attempting to cause an alert of an event; and

FIG. 8 shows a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques are not shown in detail.

Example methods and systems are directed to facilitating an alert of an event on a communication device. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some embodiments, the annoyance and inefficiency associated with having multiple communication devices providing an alert whenever an event for which an alert is appropriate occurs may be avoided by only providing an alert of the event on a preferred communication device. A preferred communication device of the user may be identified as such based on that communication device being the last communication device on which a user activity was performed. When the user performs one or more specific actions on any of his or her communication devices, that communication device may provide a notification of the action to an application. This notification may result in the maintaining of a record of the last of the user's communication devices from which such a notification was received. The last of the user's communication devices from which such a notification was received may be designated as the preferred communication device. The record of the last of the user's communication devices from which such a notification was received may be maintained on a client application on each of the user's communication devices or on a server machine.

In some embodiments, when an event for which an alert is appropriate occurs, if no communication device has been determined to be the preferred communication device, then an alert may be provided on all of the user's communication devices. If a preferred communication device has been determined, then an alert may initially be provided only on the preferred communication device, while an alert may not be provided on the other communication devices, which may be referred to as the non-preferred communication devices. This selective alerting may be performed by an application on a server machine or by a client application on a case by case basis. If this selective alerting is performed by a server machine, it may be achieved by not sending an alert-causing communication to any other communication device other than the preferred communication device or by the non-preferred communication devices suppressing an alert until a determination is made that it is appropriate to provide an alert. This determination may be made based on a determination about activity or inactivity on the preferred communication device, or about a message comprising information about the event. In some embodiments, this determination may result in a notification or recognition that the preferred communication device is no longer the preferred communication device. In some embodiments, at any time, there may be only one preferred communication device. In some embodiments, there may be no communication device that is recognized as the preferred communication device.

The system and features of the present disclosure may be employed using a client-server architecture, but are not limited to such an architecture, and could also find application in a distributed, or peer-to-peer, architecture system, for example.

In some embodiments, a method may comprise determining that a communication device of a user is a preferred communication device among a plurality of communication devices of the user based on an indication of an activity on the communication device, receiving an indication of an event, and, in response to the indication of the event, attempting to cause an alert for the event to be generated only on the preferred communication device. In some embodiments, an attempt to cause the alert for the event to be generated on the preferred communication device may be made prior to an alert for the event being caused and/or being attempted to be caused to be generated on any of the other communication devices in the plurality of communication devices (also referred to herein as “the non-preferred communication devices”). In some embodiments of the method, the communication devices may comprise a mobile phone, a tablet computer, a laptop computer, or a desktop computer.

In some embodiments of the method, the activity on the communication device may comprise at least one activity from a group of activities consisting of: an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, and sending a chat state from the communication device denoting that the user is typing a message or interacting with the keyboard within a chat application.

In some embodiments of the method, the method may further comprise attempting to cause an alert for the event to be generated on at least one of the other communication devices in the plurality of communication devices that is not the preferred communication device in response to one of a group of determinations about a message comprising information about the event. The group of determinations may consist of: a determination that the message comprising information about the event was not delivered successfully to the preferred communication device within a predetermined amount of time for a successful delivery; and a determination that the message comprising information about the event was not read on the preferred communication device within a predetermined amount of time for a successful read.

In some embodiments of the method, the method may further comprise determining that the message comprising information about the event was not read on the preferred communication device within the predetermined amount of time for a successful read based on at least one user action in a group of user actions not being performed within the predetermined amount of time for a successful read. The group of user actions may consist of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

In some embodiments of the method, the method may further comprise determining that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message.

In some embodiments of the method, attempting to cause an alert for the alert event to be generated on at least one of the other communication devices that is not the preferred communication device may further comprise at least one of: a machine sending an alert-causing communication to the at least one of the other communication devices subsequent to one of the determinations in the group of determinations about the message comprising information about the event, wherein the alert-causing communication may be configured to cause the alert for the event to be generated on the at least one of the other communication devices that is not the preferred communication device; and a machine sending an alert-causing communication to the at least one of the other communication devices prior to any determination in the group of determinations about the message comprising information about the event, wherein the alert-causing communication may be configured to cause the alert for the event to be generated on the at least one of the other communication devices that is not the preferred communication device, and the at least one of the other communication devices may suppress the generation of the alert until after one of the determinations in the group of determinations is made.

In some embodiments of the method, the method may further comprise receiving an indication that a message comprising information about the event has been read on one of the plurality of communication devices, and causing the alert to be cleared on all of the plurality of communication devices subsequent to receiving the indication that the message comprising information about the event was read.

In some embodiments of the method, the method may further comprise determining that the preferred communication device is no longer the preferred communication device among the plurality of communication devices in response to at least one of: an application on the preferred communication device that is configured to receive a message comprising information about the event being disconnected and not having a connection to a server or to the other communication devices; a determination that a message comprising information about the event was not delivered successfully to the preferred communication device within a predetermined amount of time for a successful delivery; a determination that a message comprising information about the event was not read on the preferred communication device within a predetermined amount of time for a successful read; and a determination that at least one user action has not occurred on the preferred communication device within a predetermined amount of time for user activity. The user action(s) may comprise at least one of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

In some embodiments of the method, the step of determining that a communication device is a preferred communication device among a plurality of communication devices based on an indication of an activity on the communication device may be performed by a server that receives the indication of the activity or by the communication device on which the activity takes place notifying the other communication devices in the plurality of communication devices of the activity.

In some embodiments of the method, generating an alert may comprise at least one of: showing a badge counter, showing a pop-up element containing a message containing information about the event, playing a sound, vibrating a device, and showing a notification icon.

In some embodiments, a non-transitory machine-readable storage medium may comprise instructions that, when executed by at least one processor of a machine, cause the machine to perform a set of operations comprising determining that a communication device of a user is a preferred communication device among a plurality of communication devices of the user based on an indication of an activity on the communication device, receiving an indication of an event, and, in response to the indication of the event, attempting to cause an alert for the event to be generated only on the preferred communication device. In some embodiments, an attempt to cause the alert for the event to be generated on the preferred communication device may be made prior to an alert for the event being caused and/or being attempted to be caused to be generated on any of the other communication devices in the plurality of communication devices.

In some embodiments of the machine-readable storage medium, the activity on the communication device may comprise at least one activity from a group of activities consisting of: an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, and sending a chat state from the communication device denoting that the user is typing a message or interacting with the keyboard within a chat application.

In some embodiments of the machine-readable storage medium, the set of operations may further comprise attempting to cause an alert for the event to be generated on at least one of the other communication devices in the plurality of communication devices that is not the preferred communication device in response to one of a group of determinations about a message comprising information about the event. The group of determinations may consist of: a determination that the message comprising information about the event was not delivered successfully to the preferred communication device within a predetermined amount of time for a successful delivery; and a determination that the message comprising information about the event was not read on the preferred communication device within a predetermined amount of time for a successful read.

In some embodiments of the machine-readable storage medium, the set of operations may further comprise determining that the message comprising information about the event was not read on the preferred communication device within the predetermined amount of time for a successful read based on at least one user action in a group of user actions not being performed within the predetermined amount of time for a successful read. The group of user actions may consist of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

In some embodiments of the machine-readable storage medium, the set of operations may further comprise determining that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message.

In some embodiments of the machine-readable storage medium, attempting to cause an alert for the alert event to be generated on at least one of the other communication devices that is not the preferred communication device may further comprise at least one of: a machine sending an alert-causing communication to the at least one of the other communication devices subsequent to one of the determinations in the group of determinations about the message comprising information about the event, wherein the alert-causing communication may be configured to cause the alert for the event to be generated on the at least one of the other communication devices that is not the preferred communication device; and a machine sending an alert-causing communication to the at least one of the other communication devices prior to any determination in the group of determinations about the message comprising information about the event, wherein the alert-causing communication may be configured to cause the alert for the event to be generated on the at least one of the other communication devices that is not the preferred communication device, and the at least one of the other communication devices may suppress the generation of the alert until after one of the determinations in the group of determinations is made.

In some embodiments of the machine-readable storage medium, the set of operations may further comprise receiving an indication that a message comprising information about the event has been read on one of the plurality of communication devices, and causing the alert to be cleared on all of the plurality of communication devices subsequent to receiving the indication that the message comprising information about the event was read.

In some embodiments of the machine-readable storage medium, the set of operations may further comprise determining that the preferred communication device is no longer the preferred communication device among the plurality of communication devices in response to at least one of: an application on the preferred communication device that is configured to receive a message comprising information about the event being disconnected and not having a connection to a server or to the other communication devices; a determination that a message comprising information about the event was not delivered successfully to the preferred communication device within a predetermined amount of time for a successful delivery; a determination that a message comprising information about the event was not read on the preferred communication device within a predetermined amount of time for a successful read; and a determination that at least one user action has not occurred on the preferred communication device within a predetermined amount of time for user activity. The user action(s) may comprise at least one of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

In some embodiments of the machine-readable storage medium, the step of determining that a communication device is a preferred communication device among a plurality of communication devices based on an indication of an activity on the communication device may be performed by a machine that receives the indication of the activity or by the communication device on which the activity takes place notifying the other communication devices in the plurality of communication devices of the activity.

In some embodiments of the machine-readable storage medium, generating an alert may comprise at least one of: showing a badge counter, showing a pop-up element containing a message containing information about the event, playing a sound, vibrating a device, and showing a notification icon.

In some embodiments, a system may comprise at least one processor, a preferred device determination module, and an alert module. The preferred device determination module may be executable by the at least one processor and configured to determine that a communication device of a user is a preferred communication device among a plurality of communication devices of the user based on an indication of an activity on the communication device. The alert module may be executable by the at least one processor and configured to receive an indication of an event, and, in response to the indication of the event, to attempt to cause an alert for the event to be generated only on the preferred communication device. In some embodiments, the alert module may be configured to attempt to cause the alert for the event to be generated on the preferred communication device prior to an alert for the event being caused and/or being attempted to be caused to be generated on any of the other communication devices in the plurality of communication devices. In some embodiments of the system, the communication devices may comprise a mobile phone, a tablet computer, a laptop computer, or a desktop computer.

In some embodiments of the system, the activity on the communication device may comprise at least one activity from a group of activities consisting of: an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, and sending a chat state from the communication device denoting that the user is typing a message or interacting with the keyboard within a chat application.

In some embodiments of the system, the alert module may be configured to attempt to cause an alert for the event to be generated on at least one of the other communication devices in the plurality of communication devices that is not the preferred communication device in response to one of a group of determinations about a message comprising information about the event. The group of determinations may consist of: a determination that the message comprising information about the event was not delivered successfully to the preferred communication device within a predetermined amount of time for a successful delivery; and a determination that the message comprising information about the event was not read on the preferred communication device within a predetermined amount of time for a successful read.

In some embodiments of the system, the alert module may be configured to attempt to cause an alert for the alert event to be generated on at least one of the other communication devices that is not the preferred communication device by performing one of: sending an alert-causing communication to the at least one of the other communication devices subsequent to one of the determinations in the group of determinations about the message comprising information about the event, wherein the alert-causing communication may be configured to cause the alert for the event to be generated on the at least one of the other communication devices that is not the preferred communication device; and sending an alert-causing communication to the at least one of the other communication devices prior to any determination in the group of determinations about the message comprising information about the event, wherein the alert-causing communication may be configured to cause the alert for the event to be generated on the at least one of the other communication devices that is not the preferred communication device, and the at least one of the other communication devices may be configured to suppress the generation of the alert until after one of the determinations in the group of determinations is made.

In some embodiments of the system, the preferred device determination module may be further configured to determine that the message comprising information about the event was not read on the preferred communication device within the predetermined amount of time for a successful read based on at least one user action in a group of user actions not being performed within the predetermined amount of time for a successful read. The group of user actions may consist of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

In some embodiments of the system, the preferred device determination module may be further configured to determine that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message.

In some embodiments of the system, the alert module may be further configured to receive an indication that a message comprising information about the event has been read on one of the plurality of communication devices, and to cause the alert to be cleared on all of the plurality of communication devices subsequent to receiving the indication that the message comprising information about the event was read.

In some embodiments of the system, the preferred device determination module may be further configured to determine that the preferred communication device is no longer the preferred communication device among the plurality of communication devices in response to at least one of: an application on the preferred communication device that is configured to receive a message comprising information about the event being disconnected and not having a connection to a server or to the other communication devices; a determination that a message comprising information about the event was not delivered successfully to the preferred communication device within a predetermined amount of time for a successful delivery; a determination that a message comprising information about the event was not read on the preferred communication device within a predetermined amount of time for a successful read; and a determination that at least one user action has not occurred on the preferred communication device within a predetermined amount of time for user activity. The user action(s) may comprise at least one of: an activity on an input device of the preferred communication device, an activity within any application on the preferred communication device, user activity on any input device on the preferred communication device (e.g., keyboard, touch screen, mouse, etc.), opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device. The chat state may denote that the user is typing a message or interacting with the keyboard within a chat application.

In some embodiments of the system, the preferred device determination module may reside on a machine that receives the indication of the activity from the communication device on which the activity takes place. In some embodiments of the system, the preferred device determination module may reside on the communication device on which the activity takes place, and may be configured to notify the other communication devices in the plurality of communication devices of the activity.

In some embodiments of the system, generating an alert may comprise at least one of: showing a badge counter, showing a pop-up element containing a message containing information about the event, playing a sound, vibrating a device, and showing a notification icon.

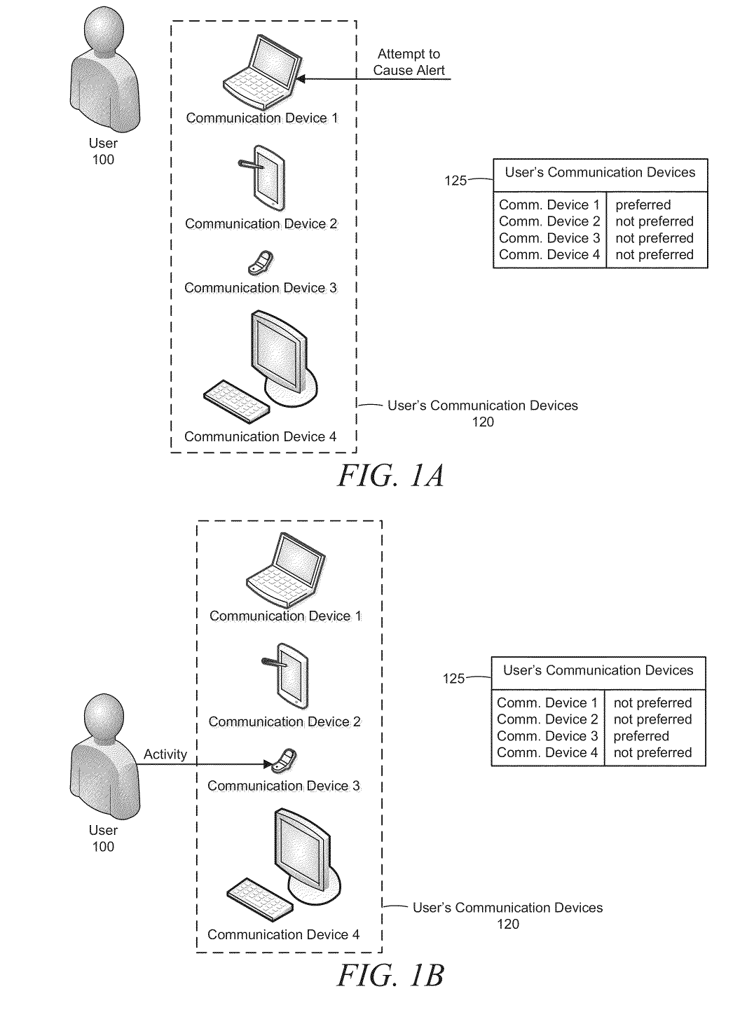

FIGS. 1A-1D illustrate example embodiments of different stages of providing an alert of an event. A user 100 may have a plurality of communications devices 120. The term “communication device” is used herein to refer to any device capable of receiving a communication from another device. The communication device may be configured to use one or more services that provide communication functionality (e.g., communication services). For example, a communication device may be connected to a network (e.g., a wired network, a wireless network, or both), and the communication device may be configured (e.g., by software, hardware, or both) to communicate (e.g., send, receive, or both) messages via the network according to one or more communications protocols supported by one or more services (e.g., communication services). Examples of such services include telephony services (e.g., analog or digital voice telephony services, including Voice over IP (VoIP) services), instant messaging (IM) services (e.g., text-based chat services, including Internet chat services), text messaging services (e.g., short message services (SMS)), video conference services (e.g., analog or digital video phone services, including webcam-based services supporting video, audio, or both), and any suitable combination thereof. Examples of communication devices include, but are not limited to, a mobile phone, a tablet computer, a laptop computer, or a desktop computer.

FIGS. 1A-1D show user 100 having four communication devices 120: communication device 1 (e.g., a laptop computer), communication device 2 (e.g., a tablet computer), communication device 3 (e.g., a mobile phone), and communication device 4 (e.g., a desktop computer). However, it is contemplated that any other number, types, and combinations of communication devices may be employed and are within the scope of the present disclosure.

Each of the user's communication devices 120 may be configured to provide an alert notifying the user 100 of an event. In some embodiments, the event may be any event that occurs within the context of, or that is otherwise related to, an application that resides on or that is otherwise in communication with one or more of the user's communication devices 120. When an event occurs, a message comprising information about the event may be configured to be consumed (e.g., read, viewed, listened to) using the application and may be made available for consumption by the user 100 via the application. For example, in some embodiments, the user 100 may install a chat messaging application on all of the user's communication devices 120. When a chat message is sent to the user 100 and available for consumption by the user 100 using the chat messaging application, an alert may be provided to the user 100 notifying the user 100 that the content of the chat message is available for viewing. The user 100 may then open the chat messaging application and read the content of the message. In another example, the user 100 may install a stock quote application on all of the user's communication devices 120. When the stock price of a stock of interest drops below a certain level, a message comprising information about this event may be sent to the user 100 and may be configured to be consumable via the stock quote application, and an alert may be provided to the user 100 notifying the user 100 that the content of the message is available for viewing. The user 100 may then open the stock quote application and read the message comprising information about the stock price of the stock of interest dropping below the certain level. In some embodiments, the message comprising information about the event may be sent to the user 100 from a machine other than one of the user's communication devices 120. In some embodiments, the message comprising information about the event may be sent to the user 100 from a service provider (e.g., from a server machine). The message comprising information about the event may be sent directly to one or more of the user's communication devices 120 or may be stored on a machine other than one of the user's communication devices 120 (e.g., via a cloud system), where it may be accessed by the user 100 using one or more of the communication devices 120.

The alert may comprise any type of indication that communicates to the user 100 that there is a message comprising information about an event and that the message is available for consumption by the user 100. In some embodiments, the alert may comprise providing, on the communication device, any one or combination of: a sound, a vibration, a light, a display of a badge counter, a display of a pop-up element containing a message with information about the event, and a display of a notification icon. It is contemplated that other types of alerts are within the scope of the present disclosure and may be combined with any of the types of alerts that are explicitly recited herein.

One of the user's communication devices 120 may be determined to be a preferred communication device based on that communication device being the last communication device on which the user 100 has performed an activity. As a result of that communication device being identified as the preferred communication device, when an event occurs, an attempt may be made to cause an alert to be generated on the currently-designated preferred communication device before any attempt is made to cause an alert to be generated on any of the other communication devices 120. Examples of activities on a communication device that may cause that communication device to be identified as the preferred communication device include, but are not limited to, an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, sending a chat state from the communication device, and unlocking or waking up the communication device. It is contemplated that other types of activities on the communication device may also be used to identify that communication device as the preferred communication device.

A record 125 may be maintained of the user's communication devices 120. The record 125 may comprise information regarding on which one of the communication devices 120 the user 100 last performed an activity. The record 125 may identify which one of the communication devices 120 is the preferred communication device based on this information. In some embodiments, this record 125 may be maintained on one or more, or all, of the user's communication devices 120. In some embodiments, this record 125 may be maintained on one or more machines other than the user's communication devices 120 (e.g., on storage device on a server machine). In some embodiments, the user 100 may register communication devices with a system in order to be recognized as the user's communication devices 120. In some embodiments, the record 125 may simply note on which one of the communication devices 120 the user 100 last performed an activity, without storing any information about the other communication devices 120. For example, in some embodiments, when one of the user's communication devices 120 is used by the user 100, a notification of this activity may be provided to the other communication devices 120, enabling these other communication devices 120 to realize that they are not the preferred communication device. In this fashion, the record 125 may be realized as the aggregate knowledge of all of the user's communication devices 120 regarding the user's latest activity on one of the communication devices 120, with each one of the communication devices 120 having information relevant to them, rather than a single record comprising information about all of the communication devices 120 being stored on a single machine. For example, in some embodiments, each one of the user's communication devices 120 may only store information on whether it is the preferred communication device (the last communication device on which a user activity was performed). However, it is contemplated that each one of the user's communication devices 120 may also store a complete record 125 of the other communication devices 120 and any information indicating which one of the communication devices 120 is the preferred communication device and which ones are not the preferred communication device.

In FIG. 1A, communication device 1 may be the preferred communication device. As a result, when the user 100 is to be alerted of an event, an attempt may first be made to cause an alert to be generated on communication device 1, before causing or attempting to cause an alert to be generated on communication devices 2, 3, or 4.

In FIG. 1B, the user 100 may perform an activity (e.g., making a phone call, sending a text message) on communication device 3. As a result, communication device 3 may be recognized as the preferred communication device.

In FIG. 1C, as a result of communication device 3 being the preferred communication device, when the user 100 is to be alerted of an event, an attempt may first be made to cause an alert to be generated on communication device 3, before causing or attempting to cause an alert to be generated on communication devices 1, 2, or 4. In some embodiments, it may be appropriate to cause an alert to be generated on the user's communication devices 120 that are not the preferred communication device. Examples of these situations will be discussed in further detail below. In such circumstances, an attempt may be made to cause an alert to be generated on the user's communication devices 120 that are not the preferred communication device.

FIG. 1D illustrates this situation, showing that an attempt may be made to cause an alert to be generated on communication devices 1, 2, and 4, none of which are the preferred communication device. In some embodiments, an attempt may be made to cause an alert to be generated on all of the user's non-preferred communication devices. In some embodiments, an attempt may be made to cause an alert to be generated on some of the user's non-preferred communication devices.

In some embodiments, a priority list of the user's communication devices 120 may be used to determine which of the non-preferred communication devices should an alert for the event be generated on next. For example, the user 100 may want an alert to first be attempted to generated on communication device 1, then on communication device 2, if deemed appropriate (e.g., if the message about the event is not delivered successfully to communication device 1), then on communication device 3, if deemed appropriate (e.g., if the message about the event is not read successfully on communication device 2), and then on communication device 4, if appropriate (e.g., if the message about the event is not read successfully on communication device 3). This priority list may be configurable by the user 100 and stored on one or more machines.

Furthermore, in some embodiments, the preferred communication device may be determined based on context information other than the user 100 performing an activity on that communication device. For example, the preferred communication device may be determined based on the current time of day, the current day of the week, the location of one or more of the user's communication devices 120, and/or a variety of other factors.

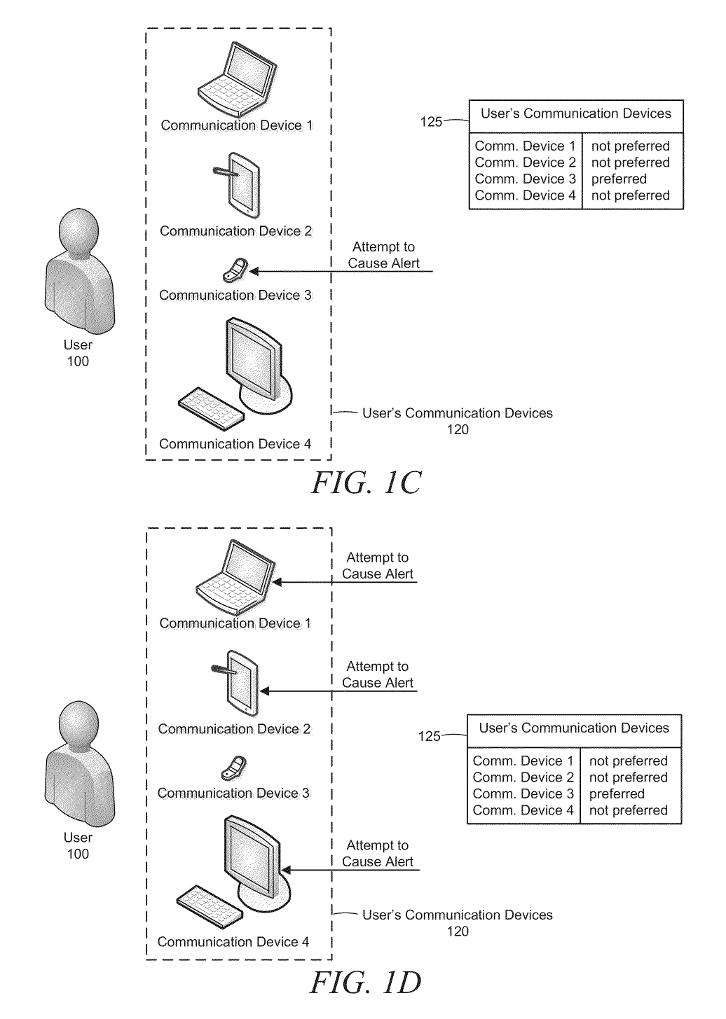

FIG. 2 is a flowchart illustrating an example embodiment of a method 200 of providing an alert of an event. The operations of method 200 may be performed by one or more machines. In some embodiments, the operations of method 200 may be performed by a server machine. In some embodiments, the operations of method 200 may be performed by one or more of the user's communication devices 120.

At operation 210, one or more machines may receive an indication of an activity performed on one of a plurality of communication devices of a user. In some embodiments, the activity may comprise, but is not limited to, at least one of the following activities: an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, and sending a chat state from the communication device. The chat state may denote that the user is typing a message or interacting with the keyboard within a chat application. However, it is contemplated that other activities are within the scope of the present disclosure.

At operation 220, one or more machines may determine that the communication device is a preferred communication device among the plurality of communication devices based on the indication of the activity performed on the communication device. In some embodiments, this determining operation may be performed by a machine that receives the indication of the activity. In some embodiments, this determining operation may be performed by the communication device on which the activity takes place notifying the other communication devices in the plurality of communication devices of the activity.

At operation 230, one or more machines may receive an indication of an event. In some embodiments, the event may be any event that occurs within the context of, or that is otherwise related to, an application that resides on or that is otherwise in communication with one or more of the user's communication devices. A message comprising information about the event may be made available for consumption by the user via the application.

At operation 240, in response to the indication of the event, one or more machines may attempt to cause an alert for the event to be generated only on the preferred communication device. In some embodiments, an attempt to cause the alert for the event to be generated on the preferred communication device may be made prior to an alert for the event being caused and/or being attempted to be caused to be generated on any of the other communication devices in the plurality of communication devices. In some embodiments, the alert may comprise any type of indication that communicates to the user that there is a message that comprises information about an event and that the message is available for consumption by the user. In some embodiments, the alert may comprise providing, on the communication device, any one or combination of: a sound, a vibration, a light, a display of a badge counter, a display of a pop-up element containing a message with information about the event, and a display of a notification icon. It is contemplated that other types of alerts are within the scope of the present disclosure and may be combined with any of the types of alerts that are explicitly recited herein.

At operation 250, one or more machines may determine whether an alert for the event should be generated on the other communication devices in the plurality of communication devices that are not the preferred communication device. In some embodiments, the one or more machines may determine that an alert for the event should be generated on the other communication devices in response to a determination that the message comprising information about the event was not delivered successfully to the preferred communication device within a predetermined amount of time for a successful delivery. In some embodiments, it may be determined that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message. In some embodiments, the one or more machines may determine that an alert for the event should be generated on the other communication devices in response to a determination that the message comprising information about the event was not read on the preferred communication device within a predetermined amount of time for a successful read. In some embodiments, it may be determined that the message comprising information about the event was not read on the preferred communication device within the predetermined amount of time for a successful read based on at least one user action in a group of user actions not being performed within the predetermined amount of time for a successful read. The group of user actions may comprise, but is not limited to, one or more of: an activity on an input device of the preferred communication device, an activity within any application on the preferred communication device, user activity on any input device on the communication device (e.g., keyboard, touch screen, mouse, etc.), opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device. The chat state may denote that the user is typing a message or interacting with the keyboard within a chat application.

If it is decided that an alert for the event should be generated on the other communication devices, then one or more machines may make such an attempt at operation 260. In some embodiments, this attempt to cause an alert for the alert event to be generated on at least one of the other communication devices that is not the preferred communication device may comprise sending an alert-causing communication to the other communication device(s). This alert-causing communication may be sent subsequent to a determination being made about the message comprising information about the event, and the alert-causing communication may be configured to cause the alert for the event to be generated on the other communication device(s). In some embodiments, the attempt to cause an alert for the alert event to be generated on at least one of the other communication devices that is not the preferred communication device may comprise sending an alert-causing communication to the other communication device(s) prior to any determination being made about the message comprising information about the event. The alert-causing communication may be configured to cause the alert for the event to be generated on the other communication device(s). The other communication device(s) may suppress the generation of the alert until after a determination is made about the message comprising information about the event. If it is decided that an alert for the event should not be generated on the other communication devices, then the method 200 may come to an end.

In some embodiments, if the message comprising information about the event is read, any alerts for the event that have been generated on any of the communication devices may be cleared. In some embodiments, alerts for the event that have been generated on any of the communication devices may be caused to be cleared from the communication devices subsequent to an indication being received that the message comprising information about the event has been read.

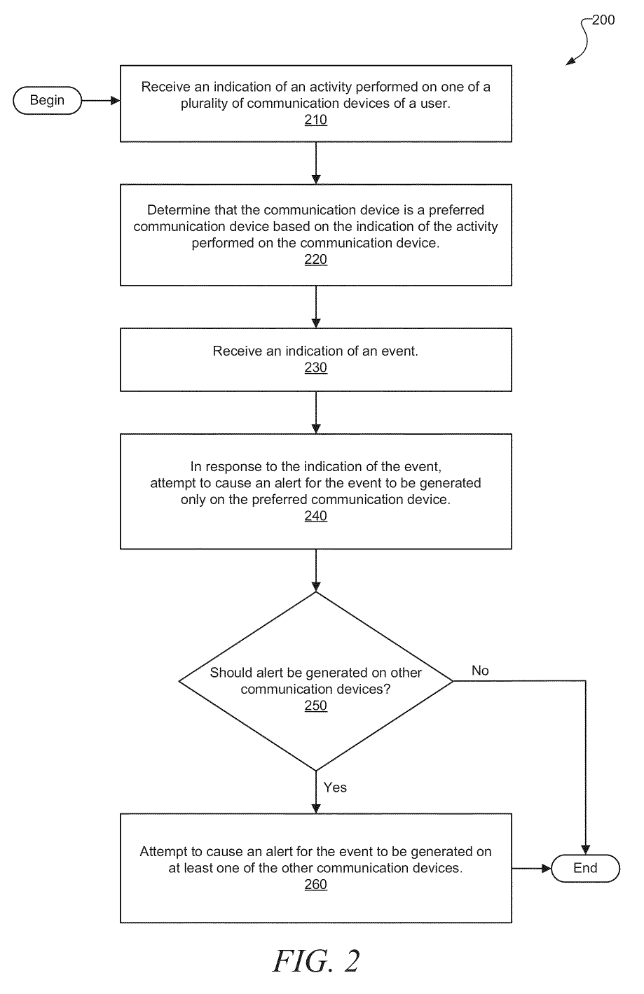

FIG. 3 is a block diagram illustrating an example embodiment of an alert system 300. The alert system 300 may comprise a preferred device determination module 310 and an alert module 320. The preferred device determination module 310 and the alert module 320 may each reside on a machine having at least one processor. In some embodiments, the preferred device determination module 310 and the alert module 320 may reside on the same machine. In some embodiments, the preferred device determination module 310 and the alert module 320 may reside on separate machines. In some embodiments, the preferred device determination module 310 and/or the alert module 320 may reside on one or more of the user's communication devices. In some embodiments, the preferred device determination module 310 and/or the alert module 320 may reside on all of the user's communication devices. In some embodiments, the preferred device determination module 310 and/or the alert module 320 may reside on one or more machines other than the user's communication devices (e.g., the preferred device determination module 310 and/or the alert module 320 may reside on one or more server machines).

The preferred device determination module 310 may be executable by a processor and be configured to determine that a communication device of a user is a preferred communication device among a plurality of communication devices of the user. The preferred device determination module 310 may make this determination based on an indication of an activity on the communication device. In some embodiments, this indication may be received from a different machine than the machine on which the preferred device determination module 310 resides. For example, if the preferred device determination module 310 resides on a server machine, then the indication may be received from one or more of the user's communication devices, and if the preferred device determination module 310 resides on one of the user's communication devices, then the indication may be received from one of the other communication devices of the user or from a server machine. In some embodiments, this indication may be received from the same machine on which the preferred device determination module 310 resides. For example, if the preferred device determination module 310 resides on one of the user's communication devices, then the indication may be received from that same communication device. In some embodiments, the preferred device determination module 310 may reside on the communication device on which the activity takes place, and may be configured to notify the user's other communication devices of the activity.

In some embodiments, the activity upon which the indication is based may comprise at least one of the following activities: an activity on an input device of the communication device, activity within any application on the communication device, user activity on any input device on the communication device (e.g., keyboard, touch screen, mouse, etc.), opening a chat application on the communication device, sending a message from the communication device, sending a read receipt from the communication device, and sending a chat state from the communication device. The chat state may denote that the user is typing a message or interacting with the keyboard within a chat application. However, it is contemplated that the activity upon which the indication is based may comprise other types of activities as well.

The alert module 320 may be executable by a processor and be configured to receive an indication of an event. The alert module 320 may also be configured to attempt to cause an alert for the event to be generated on the preferred communication device in response to the indication of the event. The alert module 320 may be configured to attempt to cause an alert for the event to be generated only on the preferred communication device. The alert module 320 may also be configured to make this attempt to cause the alert to be generated on the preferred communication device prior to causing and/or attempting to cause the alert for the event to be generated on any of the other communication devices in the plurality of communication devices. The alert module 320 may obtain knowledge of which communication device is the preferred communication device from the preferred device determination module 310.

In some embodiments, the alert may comprise at least one of: displaying a badge counter, displaying a pop-up element containing a message containing information about the event, playing a sound, vibrating a device, and displaying a notification icon. It is contemplated that other types of alerts are also within the scope of the present disclosure.

In some embodiments, the alert module 320 may also be configured to attempt to cause an alert for the event to be generated on at least one of the other communication devices in the plurality of communication devices that is not the preferred communication device. In some embodiments, the alert module 320 may be configured to make this attempt in response to a determination that the message comprising information about the event was not delivered successfully to the preferred communication device within a predetermined amount of time for a successful delivery. The alert module 320 may obtain knowledge of this determination from the preferred device determination module 310. In some embodiments, the preferred device determination module 310 may be configured to determine that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message.

In some embodiments, the alert module 320 may be configured to attempt to cause an alert for the event to be generated on at least one of the other communication devices that is not the preferred communication device in response to a determination that the message comprising information about the event was not read on the preferred communication device within a predetermined amount of time for a successful read. The alert module 320 may obtain knowledge of this determination from the preferred device determination module 310. In some embodiments, the preferred device determination module 310 may be configured to determine that the message comprising information about the event was not read on the preferred communication device within the predetermined amount of time for a successful read based on at least one user action in a group of user actions not being performed within the predetermined amount of time for a successful read. The group of user actions may comprise: an activity on an input device of the preferred communication device, an activity within any application on the preferred communication device, user activity on any input device on the communication device (e.g., keyboard, touch screen, mouse, etc.), opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device. The chat state may denote that the user is typing a message or interacting with the keyboard within a chat application. It is contemplated that other user actions may serve as the basis for a determination of whether the message comprising information about the event was read on the preferred communication device within the predetermined amount of time for a successful read.

It is contemplated that the alert module 320 may be configured to attempt to cause an alert for the event to be generated on at least one of the other communication devices that is not the preferred communication device in response to one or more other determinations.

In some embodiments, the alert module 320 may be configured to attempt to cause an alert for the event to be generated on at least one of the other communication devices that is not the preferred communication device by sending an alert-causing communication to the other communication device(s) subsequent to a determination about the message comprising information about the event. The alert-causing communication may be configured to cause the alert for the event to be generated on the other communication device(s).

In some embodiments, the alert module 320 may be configured to attempt to cause an alert for the event to be generated on at least one of the other communication devices that is not the preferred communication device by sending an alert-causing communication to the other communication device(s) prior to any determination about the message comprising information about the event. The alert-causing communication may be configured to cause the alert for the event to be generated on the other communication device(s), and the other communication device(s) may be configured to suppress the generation of the alert until after a determination about the message comprising information about the event is made.

In some embodiments, the alert module 320 may be configured to receive an indication that a message comprising information about the event has been read on one of the plurality of communication devices. In some embodiments, the alert module 320 may be configured to cause the alert to be cleared on all of the plurality of communication devices subsequent to receiving the indication that the message comprising information about the event was read.

In some embodiments, the preferred device determination module 310 may be configured to determine that the preferred communication device is no longer the preferred communication device among the plurality of communication devices. The preferred device determination module 310 may be configured to make this determination in response to at least one of: an application on the preferred communication device that is configured to receive a message comprising information about the event being disconnected and not having a connection to a server or to the other communication devices; a determination that a message comprising information about the event was not delivered successfully to the preferred communication device within a predetermined amount of time for a successful delivery; a determination that a message comprising information about the event was not read on the preferred communication device within a predetermined amount of time for a successful read; and a determination that at least one user action has not occurred on the preferred communication device within a predetermined amount of time for user activity. The user action(s) may comprise at least one of: an activity on an input device of the preferred communication device, an activity within any application on the preferred communication device, user activity on any input device on the communication device (e.g., keyboard, touch screen, mouse, etc.), opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device. The chat state may denote that the user is typing a message or interacting with the keyboard within a chat application. It is contemplated that the preferred device determination module 310 may be configured to make this determination in response to other situations as well.

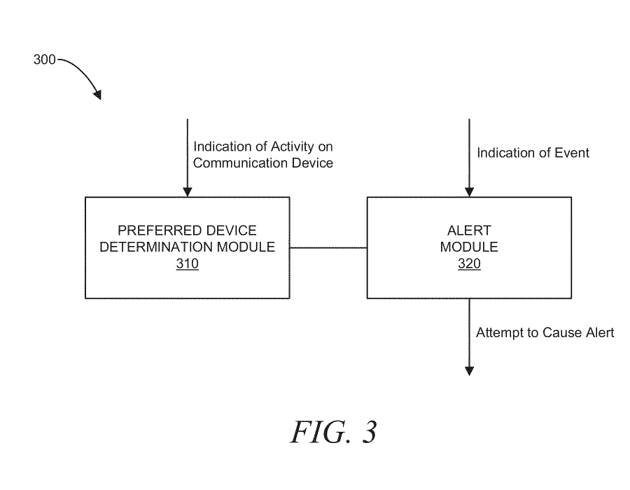

FIG. 4 illustrates an example embodiment 400 of indicating a user activity on a communication device. In some embodiments, the user 100 performs an activity on one of the communications devices (e.g., communication device 3 in FIG. 4). An indication of this activity may then be sent from the communication device on which the activity is performed to a machine that is not one of the user's communication devices 120. For example, the indication may be sent to a server machine 420 via a network 410. The network 410 may be any network that enables communication between or among machines, databases, and devices. Accordingly, the network 410 may be a wired network, a wireless network (e.g., a mobile or cellular network), or any suitable combination thereof. The network 410 may include one or more portions that constitute a private network, a public network (e.g., the Internet), or any suitable combination thereof. In some embodiments, the server machine 420, or some other machine other than one of the user's communication devices 120, may include the preferred device determination module 310. Accordingly, in some embodiments, the server machine 420, or some other machine other than one of the user's communication devices 120, may be configured to receive the indication of the activity on the communication device and to determine that the communication device on which the activity occurred is the preferred communication device based on the received indication.

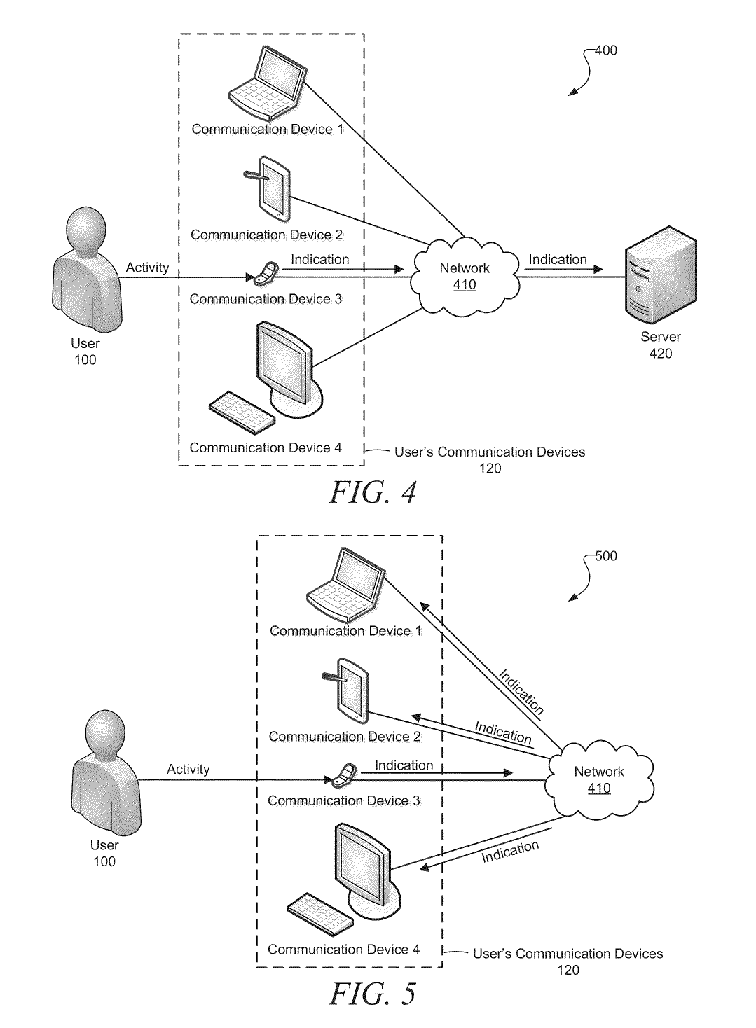

FIG. 5 illustrates another example embodiment 500 of indicating a user activity on a communication device. In some embodiments, the user 100 performs an activity on one of the communications devices (e.g., communication device 3 in FIG. 5). An indication of this activity may then be sent from the communication device on which the activity is performed to one or more of the other communication devices 120. For example, the indication may be sent to all the user's other communication devices 120 (e.g., communication devices 1, 2, and 4 in FIG. 5) via the network 410. In some embodiments, these other communication devices 120 that are not the preferred communication device may be configured to determine that the communication device on which the indicated activity occurred is the preferred communication based on the received indication. In some embodiments, one or more or all of these other communication devices 120 may include the preferred device determination module 310.

In some embodiments, in response to receiving an indication of an event, a machine (whether it be one of the communication devices 120, a server machine 420, or some other machine) may attempt to cause an alert for the event to be generated on the preferred communication device without causing an alert for the event to be generated on any of the other communication devices in the plurality of communication devices. Subsequently, it may be determined that an alert should also be generated on one or more of the other communication devices. In response to this determination, an alert may be caused to be generated on any of the other communication devices on which it is deemed appropriate to do so. In some embodiments, this subsequent alert may be caused to be generated on all of the user's communication devices 120 that are not the preferred communication device.

This subsequent alert on the non-preferred communication devices may be achieved in a variety of ways. In some embodiments, alert-causing communications may be configured to cause an alert for the event to be generated on the communication devices. In some embodiments, a machine may send an alert-causing communication to the non-preferred communication devices subsequent to a determination being made that the subsequent alert is appropriate. In some embodiments, a machine may send an alert-causing communication to the non-preferred communication devices prior to any determination being made that the subsequent alert is appropriate, and the non-preferred communication devices may suppress the generation of the alert until after a determination is made that the subsequent alert is appropriate.

In some embodiments, the determination that the subsequent alert is appropriate may be made based on a determination about activity or inactivity on the preferred communication device or about a message comprising information about the event. In some embodiments, the determination that the subsequent alert is appropriate may be made in response to a determination that the message comprising information about the event was not delivered successfully to the preferred communication device within a predetermined amount of time for a successful delivery. In some embodiments, it may be determined that the message comprising information about the event was not delivered successfully to the preferred communication device within the predetermined amount of time for a successful delivery based on an acknowledgement (ACK) packet not being received from the preferred communication device within the predetermined amount of time for a successful delivery. The communication device may be configured to send an ACK packet upon receiving such a message. In some embodiments, the determination that the subsequent alert is appropriate may be made in response to a determination that the message comprising information about the event was not read on the preferred communication device within a predetermined amount of time for a successful read. In some embodiments, it may be determined that the message comprising information about the event was not read on the preferred communication device within the predetermined amount of time for a successful read based on at least one user action in a group of user actions not being performed within the predetermined amount of time for a successful read. The group of user actions may comprise: an activity on an input device of the preferred communication device, an activity within any application on the preferred communication device, user activity on any input device on the communication device (e.g., keyboard, touch screen, mouse, etc.), opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device. The chat state may denote that the user is typing a message or interacting with the keyboard within a chat application.

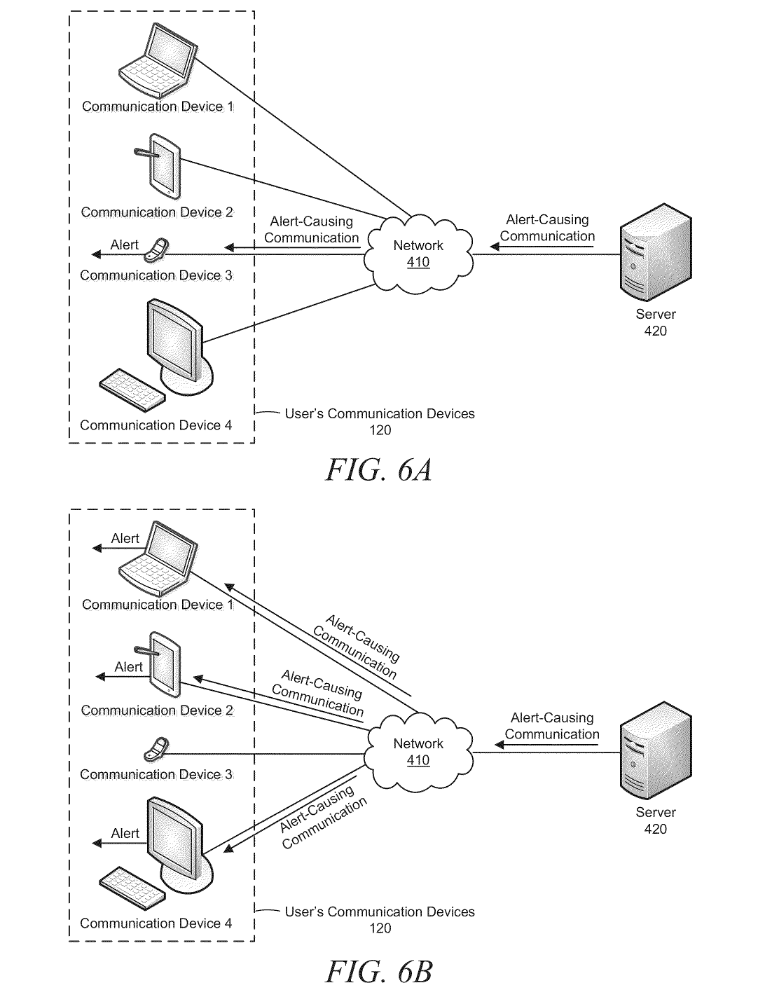

FIGS. 6A-6B illustrate example embodiments of different stages of attempting to cause an alert of an event, where an alert-causing communication is sent to the non-preferred communication devices subsequent to a determination being made that the subsequent alert is appropriate. In FIG. 6A, the server machine 420 (or some other machine) may send the alert-causing communication to the preferred communication device (e.g., communication device 3 in FIGS. 6A-6B) via network 410. As shown in FIG. 6A, in some embodiments, the preferred communication device may receive the alert-causing communication and generate an alert that may be provided to the user. However, in some embodiments, the alert-causing communication may not be received by the preferred communication device or the preferred communication device may fail to generate an alert. In some embodiments, a determination may be made that a subsequent alert on the non-preferred communication devices (e.g., communication devices 1, 2, and 4 in FIGS. 6A-6B) is appropriate. As previously discussed, in some embodiments, this determination may be made based on a determination about activity or inactivity on the preferred communication device (e.g., a user action has not occurred on the preferred communication device within a predetermined amount of time) or about a message comprising information about the event (e.g., the message was not delivered or read within a predetermined amount of time). In response to this determination, the server machine 420 (or some other machine) may send the alert-causing communication to the non-preferred communication devices (e.g., communication devices 1, 2, and 4 in FIGS. 6A-6B) via network 410. As shown in FIG. 6B, in some embodiments, each of the non-preferred communication devices may receive the alert-causing communication and generate an alert that may be provided to the user. However, in some embodiments, the alert-causing communication may not be received by some or all of the non-preferred communication devices or some or all of the non-preferred communication devices may fail to generate an alert.

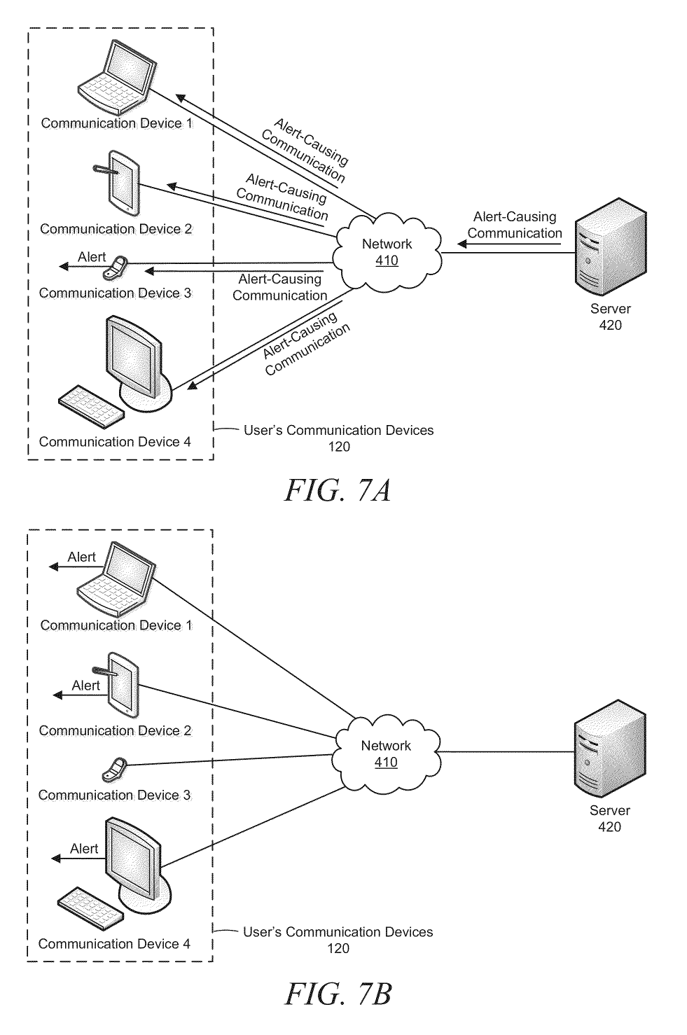

FIGS. 7A-7B illustrate other example embodiments of different stages of attempting to cause an alert of an event, where an alert-causing communication is sent to the non-preferred communication devices prior to any determination being made that the subsequent alert is appropriate, and the non-preferred communication devices suppress the generation of the alert until after a determination is made that the subsequent alert is appropriate. In FIG. 7A, the server machine 420 (or some other machine) may send the alert-causing communication to all of the user's communication devices 120 via network 410. As shown in FIG. 7A, in some embodiments, the preferred communication device (e.g., communication device 3 in FIGS. 7A-7B) may receive the alert-causing communication and generate an alert that may be provided to the user. However, in some embodiments, the alert-causing communication may not be received by the preferred communication device or the preferred communication device may fail to generate an alert. Although the non-preferred communication devices (e.g., communication devices 1, 2, and 4 in FIGS. 7A-7B) may receive the alert-causing communication, they may suppress the generation of an alert until after a determination is made that the subsequent alert on one or more of the non-preferred communication devices is appropriate

As previously discussed, in some embodiments, this determination may be made based on a determination about activity or inactivity on the preferred communication device (e.g., a user action has not occurred on the preferred communication device within a predetermined amount of time) or about a message comprising information about the event (e.g., the message was not delivered or read within a predetermined amount of time). As seen in FIG. 7B, in response to this determination, the non-preferred communication devices may generate an alert that may be provided to the user. However, in some embodiments, some or all of the non-preferred communication devices may fail to generate an alert.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 410 of FIGS. 4-7B) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

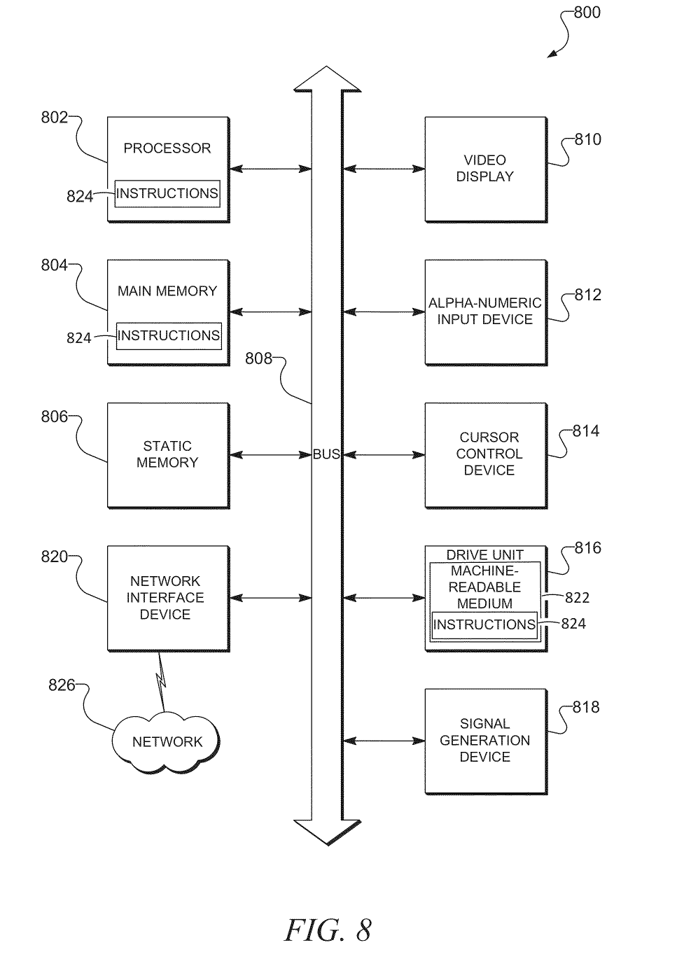

FIG. 8 is a block diagram of a machine in the example form of a computer system 800 within which instructions 824 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
determining that a communication device of a user is a preferred communication device among a plurality of communication devices of the user based on an indication of an activity on the communication device;
receiving an indication of an event; and
in response to the indication of the event, attempting to cause an alert for the event to be generated only on the preferred communication device.

2. The method of claim 1, wherein the activity on the communication device comprises at least one activity from a group of activities consisting of: an activity on an input device of the communication device, activity within an application on the communication device, opening a chat application on the communication device, sending a message from the communication device, sending a read receipt from the communication device, and sending a chat state from the communication device.

3. The method of claim 1, further comprising attempting to cause an alert for the event to be generated on at least one of the other communication devices in the plurality of communication devices that is not the preferred communication device in response to one determination of a group of determinations being made about a message comprising information about the event, the group of determinations consisting of:
a determination that the message comprising information about the event was not delivered successfully to the preferred communication device within a predetermined amount of time for a successful delivery; and
a determination that the message comprising information about the event was not read on the preferred communication device within a predetermined amount of time for a successful read.

4. The method of claim 3, further comprising determining that the message comprising information about the event was not read on the preferred communication device within the predetermined amount of time for a successful read based on at least one user action in a group of user actions not being performed within the predetermined amount of time for a successful read, the group of user actions consisting of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

5. The method of claim 3, further comprising determining that the message comprising information about the event was not delivered successfully to the preferred communication device within the predetermined amount of time for a successful delivery based on an acknowledgement (ACK) packet not being received from the preferred communication device within the predetermined amount of time for a successful delivery.

6. The method of claim 3, wherein attempting to cause the alert for the event to be generated on at least one of the other communication devices that is not the preferred communication device further comprises at least one of:
a machine sending an alert-causing communication to the at least one of the other communication devices subsequent to one of the determinations in the group of determinations about the message comprising information about the event, the alert-causing communication being configured to cause the alert for the event to be generated on the at least one of the other communication devices that is not the preferred communication device; and
a machine sending an alert-causing communication to the at least one of the other communication devices prior to any determination in the group of determinations about the message comprising information about the event, the alert-causing communication being configured to cause the alert for the event to be generated on the at least one of the other communication devices that is not the preferred communication device, the at least one of the other communication devices suppressing the generation of the alert until after one of the determinations in the group of determinations.

7. The method of claim 1, further comprising:
receiving an indication that a message comprising information about the event has been read on one of the plurality of communication devices; and
subsequent to receiving the indication that the message comprising information about the event was read, causing the alert to be cleared on the communication devices on which the alert for the event was generated.

8. The method of claim 1, further comprising determining that the preferred communication device is no longer the preferred communication device among the plurality of communication devices in response to at least one of:
an application on the preferred communication device being disconnected from a machine, wherein a message comprising information about the event is configured to be read within the application;
a determination that a message comprising information about the event was not delivered successfully to the preferred communication device within a predetermined amount of time for a successful delivery;
a determination that a message comprising information about the event was not read on the preferred communication device within a predetermined amount of time for a successful read; and
a determination that at least one user action has not occurred on the preferred communication device within a predetermined amount of time for user activity, the at least one user action comprising at least one of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

9. The method of claim 1, wherein the step of determining that a communication device is a preferred communication device among a plurality of communication devices based on the indication of the activity on the communication device is performed by a machine that receives the indication of the activity or the communication device on which the activity takes place notifying the other communication devices in the plurality of communication devices of the activity.

10. The method of claim 1, wherein generating an alert comprises at least one of: showing a badge counter, showing a pop-up element containing a message containing information about the event, playing a sound, vibrating a device, and showing a notification icon.

11. The method of claim 1, wherein the preferred communication device comprises a mobile phone, a tablet computer, a laptop computer, or a desktop computer.

12. A non-transitory machine-readable storage medium comprising instructions that, when executed by at least one processor of a machine, cause the machine to perform a set of operations comprising:
determining that a communication device of a user is a preferred communication device among a plurality of communication devices of the user based on an indication of an activity on the communication device;
receiving an indication of an event; and
in response to the indication of the event, attempting to cause an alert for the event to be generated only on the preferred communication device.

13. The non-transitory machine-readable storage medium of claim 12, wherein the activity on the communication device comprises at least one activity from a group of activities consisting of: an activity on an input device of the communication device, activity within an application on the communication device, opening a chat application on the communication device, sending a message from the communication device, sending a read receipt from the communication device, and sending a chat state from the communication device.

14. The non-transitory machine-readable storage medium of claim 12, wherein the set of operations further comprises attempting to cause an alert for the event to be generated on at least one of the other communication devices in the plurality of communication devices that is not the preferred communication device in response to one of a group of determinations being made about a message comprising information about the event, the group of determinations consisting of:
a determination that the message comprising information about the event was not delivered successfully to the preferred communication device within a predetermined amount of time for a successful delivery; and
a determination that the message comprising information about the event was not read on the preferred communication device within a predetermined amount of time for a successful read.

15. The non-transitory machine-readable storage medium of claim 14, wherein the set of operations further comprises determining that the message comprising information about the event was not read on the preferred communication device within the predetermined amount of time for a successful read based on at least one user action in a group of user actions not being performed within the predetermined amount of time for a successful read, the group of user actions consisting of: an activity on an input device of the preferred communication device, an activity within an application on the preferred communication device, opening a chat application on the preferred communication device, an action within a chat application on the preferred communication device, an action within a chat tab, an action on the preferred communication device, sending a message from the preferred communication device, sending a read receipt from the preferred communication device, and sending a chat state from the preferred communication device.

16. The non-transitory machine-readable storage medium of claim 14, wherein the set of operations further comprises determining that the message comprising information about the event was not delivered successfully to the preferred communication device within the predetermined amount of time for a successful delivery based on an acknowledgement (ACK) packet not being received from the preferred communication device within the predetermined amount of time for a successful delivery.

17. A system comprising:
at least one processor;
a preferred device determination module, executable by the at least one processor, configured to determine that a communication device of a user is a preferred communication device among a plurality of communication devices of the user based on an indication of an activity on the communication device; and
an alert module, executable by the at least one processor, configured to:
receive an indication of an event; and
in response to the indication of the event, attempt to cause an alert for the event to be generated only on the preferred communication device.

18. The system of claim 17, wherein the activity on the communication device comprises at least one activity from a group of activities consisting of: an activity on an input device of the communication device, activity within an application on the communication device, opening a chat application on the communication device, sending a message from the communication device, sending a read receipt from the communication device, and sending a chat state from the communication device.

19. The system of claim 17, wherein the alert module is configured to attempt to cause an alert for the event to be generated on at least one of the other communication devices in the plurality of communication devices that is not the preferred communication device in response to one determination of a group of determinations about a message comprising information about the event, the group of determinations consisting of:
a determination that the message comprising information about the event was not delivered successfully to the preferred communication device within a predetermined amount of time for a successful delivery; and
a determination that the message comprising information about the event was not read on the preferred communication device within a predetermined amount of time for a successful read.

20. The system of claim 19, wherein the alert module is configured to attempt to cause the alert for the event to be generated on at least one of the other communication devices that is not the preferred communication device by performing one of:
sending an alert-causing communication to the at least one of the other communication devices subsequent to one of the determinations in the group of determinations about the message comprising information about the event, the alert-causing communication being configured to cause the alert for the event to be generated on the at least one of the other communication devices that is not the preferred communication device; and
sending an alert-causing communication to the at least one of the other communication devices prior to any determination in the group of determinations about the message comprising information about the event, the alert-causing communication being configured to cause the alert for the event to be generated on the at least one of the other communication devices that is not the preferred communication device, wherein the at least one of the other communication devices is configured to suppress the generation of the alert until after one of the determinations in the group of determinations.
